(19) United States
(12) Patent Application Publication
(10) Pub. No.: US 2016/0196078 A1
(43) Pub. Date: Jul. 7, 2016

(54) MESH TOPOLOGY STORAGE CLUSTER WITH AN ARRAY BASED MANAGER

(71) Applicant: Hewlett Packard Enterprise Development LP, Houston, TX (US)

(72) Inventors: James D. Preston, Houston, TX (US); Siamak Nazari, Fremont, CA (US); Rodger Daniels, Boise, ID (US)

(73) Assignee: Hewlett Packard Enterprise Development LP, Houston, TX (US)

(21) Appl. No.: 14/915,895

(22) PCT Filed: Sep. 5, 2013
(86) PCT No.: PCT/US13/58204

§ 371 Date: Mar. 1, 2016

(51) Int. Cl. G06F 3/06; G06F 12/08

(52) U.S. Cl. CPC G06F 3/0619; G06F 12/0815; G06F 3/0689; G06F 3/0665; G06F 2212/621

(57) ABSTRACT

Example embodiments relate to a mesh topology storage cluster with art array based manager. The mesh topology storage may include a first pair of controller nodes to access a first storage volume, and a second pair of controller nodes to access a second storage volume. The mesh topology storage may include an array based manager (ABM) associated with the first pair of controller nodes to monitor paths to the first storage volume via the first pair of controller nodes and to monitor paths to the second storage volume via the second pair of controller nodes. The mesh topology storage may include a passive component associated with the second pair of controller nodes to route ABM-type communications of the second pair of controller nodes to the ABM.

### BACKGROUND

With the increased demand for highly available, flexible and scalable storage, various organizations have implemented storage clusters. A storage cluster may include a number of storage volumes and a number of controller nodes that provide access to these storage volumes. Host computing devices (or simply “hosts”) may connect to at least one of the controller nodes of the storage cluster to access at least one of the storage volumes. Various storage clusters may provide hosts with multiple physical paths to the same storage volume, e.g., for redundancy in the case of a failure.

### BRIEF DESCRIPTION OF THE DRAWINGS

The following detailed description references the drawings, wherein:

FIG. 1 is a block diagram of an example mesh topology storage cluster with a single array based manager;

FIG. 2 is a block diagram of an example 4-node cluster with two enclosures and a single array based manager in one of the enclosures;

FIG. 3 is a flowchart of an example method for using a single array based manager in a mesh topology storage cluster; and

FIG. 4 is a block diagram of an example mesh topology storage cluster with a single array based manager.

### DETAILED DESCRIPTION

In some storage clusters, at least some of the controller nodes may be connected to other controller nodes in the same storage cluster. Some storage clusters may be arranged according to a mesh topology, which means that every controller node of the storage cluster is connected to every other controller node of the same storage cluster. Such a storage cluster may be referred to as a “mesh topology storage cluster.” Mesh topology storage clusters may cluster any number (e.g., 2, 4, 8, 16, etc.) of controller nodes together. Some storage clusters may include a number of enclosures, for example, where each enclosure includes a number of (e.g., two) controller nodes. Each controller node in the storage cluster may be connected to every other controller node, for example, such that a cache coherency path exists between every possible pair of controller nodes. Controller node pairs within the same enclosure may be connected internally within the enclosure, e.g., via Ethernet. Controller node pairs that span different enclosures may be connected via external cables e.g., PCle cables.

For some mesh topology storage clusters, in addition to the cache coherency connections between controller nodes, each controller node may also be connected (e.g., via Ethernet) to an external (e.g., central) server, for example, referred to as a service processor. The service processor may monitor paths to various storage volumes of the storage cluster, paths that may pass through various controller nodes. The service processor may, for example, determine when one path to a storage volume is down, and may indicate an alternate path to the same storage volume. The service processor may log such events and may provide alerts (e.g., to a system administrator) for particular events in certain scenarios. The service processor is a dedicated server (e.g., independent computing device or group of connected computing devices); thus, the service processor may be costly to purchase, install and maintain. Additionally, it may be difficult and inconvenient to route cables from all the controller nodes in the storage cluster to the service processor. For example, an external Ethernet switch and multiple Ethernet cables may be required.

The present disclosure describes a mesh topology storage cluster with a single array based manager (ABM), for example, a storage cluster that includes two enclosures, each with two controller nodes, creating a four-node cluster. The ABM may perform functions that are similar to a service processor (mentioned above), but the ABM may be integrated into one of the enclosures (e.g., a first enclosure) of the storage cluster. The single integrated ABM may service all (e.g., four) controller nodes in all enclosures (e.g., a first enclosure and a second enclosure) of the storage cluster, without requiring additional cabling between enclosures of the storage cluster. Additionally, existing best practices for cache coherency wiring (i.e., a standard connectivity scheme) may be maintained. The ABM module may be directly connected to the controller nodes located in the same enclosure (e.g., the first enclosure) as the ABM. The ABM may be indirectly connected to the controller nodes in the second enclosure via the controller nodes in the first enclosure and via cache coherency connections that already exist between the first enclosure and the second enclosure in a mesh topology storage cluster configuration. The second enclosure may include a passive component to route ABM-type communications of controller nodes of the second enclosure back through those controller nodes, to the controller nodes in the first enclosure (e.g., via cache coherency connections that already exist), and eventually to the single ABM in the first enclosure.

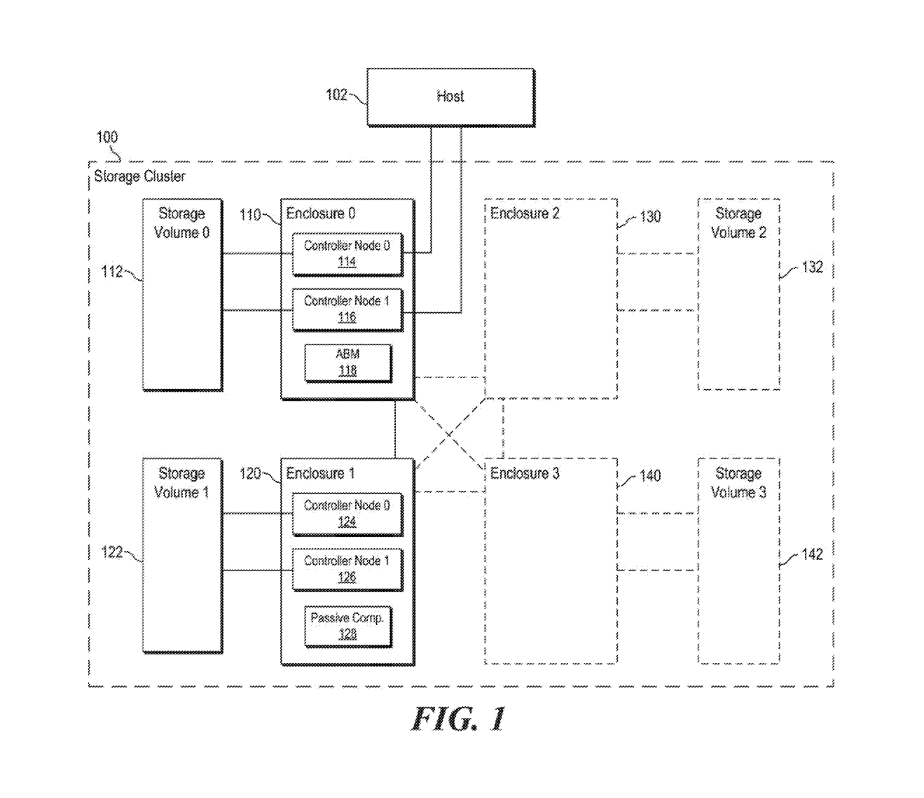

FIG. 1 is a block diagram of an example mesh topology storage cluster 100 with a single array based manager (ABM) 118. Storage cluster 100 may be in communication (e.g., via a SAN or other type of network) with at least one host (e.g., 102). Host 102 may access at least one storage volume (e.g., 112) of storage cluster 100. Host 102 may be any type of computing device that is capable of connecting to and using remote storage such as storage cluster 100. Host 102 may be, for example, an application server, a mail server, a database server or various other types of servers. Storage cluster 100 may include a number of enclosures (e.g., 110, 120, 130, 140). Each enclosure may be connected to at least one storage volume (e.g., 112, 122, 132, 142). Each enclosure may be connected to every other enclosure in the storage array, as shown in FIG. 1. More specifically, the controller nodes in each enclosure may be connected to the controller nodes in every other enclosure.

The number of enclosures and storage volumes in the storage, cluster may depend on the complexity of the storage cluster, for example, as configured by a system administrator. Referring to FIG. 1, and ignoring the dashed lines for the moment, storage cluster 100 may include, for example, two enclosures (e.g., 110, 120) and two storage volumes (e.g. 112, 122). In this example, enclosure 110 is connected to enclosure 120, e.g., via PCIe cables. The connections between enclosure 110 and 120 may allow the controller nodes within these enclosures to be part of a single cluster, e.g., by providing cache-coherency paths between each controller node and every other node in the cluster. As one specific example, because of these cache coherency paths, host 102 may be able to access (e.g., via controller node 124 or via controller node 126) storage volume 122 in enclosure 120 even though host 102 may only be connected to the controller nodes in enclosure 110. It should be understood, however, that host 102 may also be in alternate configurations, connected directly to the controller nodes in enclosure 120. Various connection configurations may offer different levels of redundancy, for example.

In alternate example configurations, storage cluster 100 may include more than two enclosures, for example, four enclosures (e.g., 110, 120, 130, 140) or even more enclosures la a mesh topology fashion, when the number of enclosures is greater than two (e.g., four enclosures), each enclosure is connected (e.g., via PCle cables) to every other enclosure, as shown in FIG. 1 (now considering the dashed lines). In the present disclosure, various descriptions may refer to a storage cluster with two enclosures, but it should be understood that the solutions described herein may be used for various other storage cluster configurations, for example, those with more than two enclosures. Likewise, various descriptions may refer to a four-node storage cluster, but it should be understood that the solutions described herein may be used for various other storage cluster configurations, for example, those with more than four controller nodes (e.g., 8, 16, etc).

Each storage volume (e.g., 112, 122) may be any storage system that contains multiple storage devices (e.g., hard drives). For example, storage volumes 112 and 122 may each be a RAID (redundant array of independent disks) system with multiple spinning disk hard drives. As another example, storage volumes 112, 122 may each be a storage system with multiple optical drives or multiple tape drives. The multiple, storage devices (e.g., hard drives) in a particular storage volume (e.g., 112) may be consolidated and presented to servers (e g., to host 102) as a single logical storage unit. Thus, for example, storage volume 112 may appear to host 102 as essentially a single local hard drive, even though storage volume 112 may include multiple storage devices.

Each enclosure (e.g., 110, 120) may include at least one controller node (e.g., 114 and 116 for enclosure 110; 124 and 126 for enclosure 120). In the example of FIG. 1, each enclosure includes two controller nodes, where each controller node is connected to the storage volume associated with the particular enclosure The term “enclosures” as used throughout this disclosure may refer to a grouping of controller nodes (e.g., two controller nodes), as well as other computing components that may be associated with the controller nodes (e.g., an intercontroller component and an ABM or passive component). The term enclosure may in some specific examples, refer to a physical enclosure such as a computer case or the like. However, it should be understood that a physical enclosure need not be used. Controller nodes and related components may be grouped without a physical enclosure.

Each controller node may be connected to at least one host (e.g., 102). In the example of FIG. 1, enclosure 110 may include two controller nodes (e.g., 114, 116) such that hosts (e.g., 102) may have two independent physical paths to storage volume 112. For example, a first path may route through controller node 114 and a second path may route through controller node 116. The same may go for enclosure 120, for example, if a host (e.g., host 102 or a different host) were connected to the controller nodes of enclosure 120.

Each controller node (e.g., 114, 116) may be implemented as a computing device, for example, any computing device that is capable of communicating with at least one host (e.g., 102) and with at least one storage volume (e.g., 112). In some examples, multiple controller nodes (e.g., 114 and 116) may be implemented by the same computing device, for example, where each controller node is run by a different virtual machine or application of the computing device, in general, the controller nodes (e.g., 114, 116) may monitor the state of the storage devices (e.g., hard drives) that make up the storage volume (e.g., 112), and may handle requests by hosts (e.g., 102) to access the storage volume via various physical paths.

In the example of FIG. 1, one of the enclosures (e.g., 110) may include an array based manager (ABM) 118. The ABM may perform functions that are similar to a service processor (mentioned above). For example, ABM 118 may monitor paths to various storage volumes of the storage cluster, paths that may pass through various controller nodes. ABM 118 may, for example, determine when one path to a storage volume (e.g., 112) is down, and may indicate an alternate path to the same storage volume. ABM 118 may log such events and may provide alerts (e.g., to a system administrator) for particular events in certain scenarios. Unlike the service processor described above, ABM 118 is not a dedicated server. Instead, ABM 118 may be a computing component (e.g., a circuit board) that is integrated into one of the enclosures (e.g., 110) of the storage cluster.

It may be the case that in a particular storage cluster (e.g., 100), only a single ABM (e.g., 118) can be active, and that ABM may service all the controller nodes of the storage cluster. Thus, in the four node example of FIG. 1, ABM 118 may service both controller nodes 114, 116 in enclosure 110 and both controller nodes 124, 126 in enclosure 120. Additionally, in enclosure 120, an ABM may not be installed, or if an ABM exists in enclosure 120, it may be deactivated. In order for ABM 118 to service all controller nodes of the storage cluster, ABM 118 may be connected to all the controller nodes in both enclosure 110 and enclosure 120. ABM 118 may directly connect (e.g., via Ethernet) to the controller nodes (e.g., 114, 116) that are located in the same enclosure as the ABM. ABM 118 may connect to other controller nodes of the storage cluster via connections (e.g., PCle cables) that already exist to connect enclosures of the storage cluster, e.g., for cache coherency purposes. Because the ABM is not an independent server, the ABM may be cheaper to purchase, install and maintain and easier to deploy. Additionally, an administrator may not have to route additional cables between all the controller nodes and between the enclosures to connect all the controller nodes to the ABM.

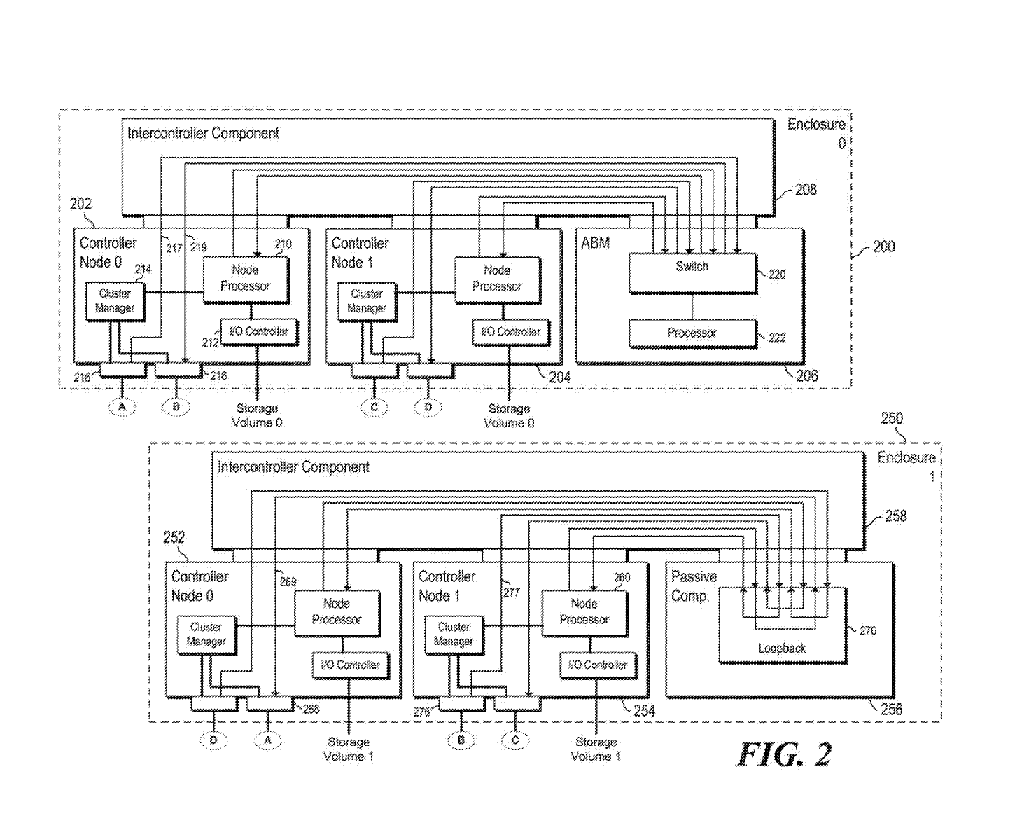

In the example of FIG. 1, the enclosure(s) other than the one that includes the single active ABM may include a passive component. As mentioned above, it may be the case that in a particular storage cluster, only a single ABM can be active. Thus, the passive component(s) may route ABM-type communications from controller nodes of enclosures without the active ABM to the single active ABM. This routing may occur via connections that already exist to connect enclosures of the storage cluster, e.g., for cache coherency purposes. In the two-enclosure storage cluster of FIG. 1, enclosure 120 may include passive component 128, for example. Likewise, in the four-enclosure storage cluster, enclosures 120, 130 and 140 may each include a passive component. The passive component may be installed in place of where an ABM may have been installed if the enclosure included an active ABM, as shown more clearly in FIG. 2.

FIG. 2 is a block diagram of an example 4-node cluster with two enclosures (e.g., 200 and 250) and a single array based manager (ABM) 206 in one of the enclosures (e.g., 200). The example of FIG. 2 shows two enclosures with two controller nodes in each enclosure, but it should be understood that the solutions of the present disclosure may be used with more or less enclosures and/or more or less controller nodes in each enclosure. Enclosure 200 may be similar to enclosure 110 of FIG. 1 and enclosure 250 may be similar to enclosure 120. Enclosure 200 may be connected to a storage volume 0, and enclosure 250 may be connected to a storage volume 1, as shown in FIG. 2. Storage volume 0 may be similar to storage volume 112 of FIG. 1, and storage volume 1 may be similar to storage volume 122. Enclosure 200 may be connected to enclosure 250 via interfaces (e.g., 216, 218) in the controller nodes and connections (e.g., PCle cables), indicated by ovals “A”, “B”, “C” and “D” shown in FIG. 2. These connections may provide each controller node of the storage cluster with a cache coherency path to every other controller node in the storage cluster.

In the example of FIG. 2, enclosure 200 may include two controller nodes 202, 204. Enclosure 200 may also include an array based manager (ABM) 206, which may be described in more detail below. Enclosure 200 may also include an intercontroller component 208, which may be a computing component (e.g., a circuit board) that is integrated into enclosure 200. Intercontroller component 208 may provide direct connections (e.g., Ethernet connections) between various components of enclosure 200. For example, intercontroller component 208 may directly connect controller node 202 to controller node 204, and may directly connect controller nodes 202, 204 to ABM 206.

Controller nodes 202, 204 may each include a node processor, as shown in FIG. 2. For each controller node, the node processor (e.g., 210) may serve as the central processing unit for the controller node (e.g., 202). The node processor may, for example, handle input/output (I/O) functions between the controller node and at least one storage volume (e.g., storage volume 0). In particular, the node processor (e.g., 210) may run an operating system (OS) that runs drivers to interface with an I/O controller (e.g., 212), which in turn may interlace with the storage volume.

As shown in FIG. 2, each controller node may include a cluster manager. The cluster manager (e.g., 214) may be controlled, for example, by a driver that runs on an OS that runs on the node processor (e.g., 210). The cluster manager be, for example, an application specific integrated circuit (ASIC) or other type of circuit board or computer component. The cluster manager (e.g., 214) may manage paths between the containing controller node (e.g., 202) and other controller nodes (e.g., other controller nodes in other enclosures). For example, the cluster manager may perform RAID-on-a-chip type functions. The cluster manager may include a cache and may handle cache coherency functions for data in various storage volumes, for example, a local storage volume (e.g., storage volume 0) and/or storage volumes connected to other enclosures.

Each controller node (e.g., 202) may include connections between the node processor (e.g., 210) and intercontroller component 208, as shown in FIG. 2, such that the node processor can directly connect to ABM 206. Each controller node may also include connections (e.g., 217, 219) between the interfaces (e.g., 216, 218) that connect to controller nodes in other enclosures and intercontroller component 208, as shown in FIG. 2, such that the controller nodes in other enclosures can indirectly connect to ABM 206. In some examples, where the storage cluster includes more controller nodes (e.g., 8 controller nodes), each controller node may include more interfaces to connect to the additional controller nodes, and may also include more connections between these interfaces and the intercontroller component. In some examples, where the storage cluster includes only a single enclosure and only two controller nodes, these connections between the interfaces and the intercontroller component may be unused or “don't-care.” Thus, it may be the case that each controller node is designed to accommodate a maximum number of controller nodes, and then if less than the maximum controller nodes are used, a number of the connections (e.g., 217, 219) may be unused. In this respect, a single controller node design may be used for various storage cluster configurations (e.g., 2 node, 4 node, etc.). Likewise, it may be the case that the single active ABM (e.g., 206) is designed to accommodate a maximum number of controller nodes, and then if less than the maximum controller nodes are used, a number of the connections into switch 220 may be unused. In this respect, a single ABM design may be used for various storage cluster configurations (e.g., 2 node, 4 node, etc.).

ABM 206 may be directly connected to controller nodes 202, 204 via intercontroller component 208. ABM 206 may be indirecity connected to controller nodes in other enclosures (e.g., enclosure 250) via intercontroller component 208 and controller nodes 202, 204. ABM 206 may include a processor 222, which may include electronic circuitry and/or execute instructions to perform various functions of the ABM (e.g., to monitor paths to various storage volumes via controller nodes, etc.). Processor 222 may be connected (e.g., via Ethernet) to a switch 220 of ABM 206, which may allow processor 222 to communicate with various controller nodes (e.g., local controller nodes and controller nodes in external enclosures). In particular, as shown in the four-node example of FIG. 2, four ports of switch 220 may be used to connect internally to controller nodes 202, 204. In this example, four more ports of switch 220 may be used to connect to controller nodes in enclosure 250. The connection paths to controller nodes in enclosure 250 may route through controller nodes 202, 204, to the interfaces (e.g., 216, 218) of these controller nodes and then over existing connections (e.g., PCIe cables) to enclosure 250. In order to use these existing connections which are also used for cache coherency purpose, unused or spare pins or wires of these connections may be used. The terms unused or spare in this context may refer to pins or wires in the existing cache coherency connections that are not used for cache coherency purposes. Thus, no additional cabling or wires need to be added to connect a single ABM to controller nodes in multiple enclosures. In short, the enclosures and the storage cluster in general do not need to be modified to accommodate different configurations of nodes (e.g., 2-node, 4-node, etc.).

Enclosure 250 may be similar to enclosure 200 in several respects. For example, controller nodes 252, 254 may be similar to controller nodes 202, 204. Likewise, intercontroller component 258 may be similar to intercontroller component 208. In the example of FIG. 2, in enclosure 250, in place of an ABM (e.g., like 206), enclosure 250 may include a passive component 256. Controller nodes 252, 254 may be connected to passive component 256 similarly to how controller nodes 202, 204 are connected to ABM 206. Thus, node processors in controller nodes 252, 254 may attempt to communicate with an ABM that they believe exists where passive component 256 is connected. These types of communications (i.e., attempts to communicate with an ABM) may be referred to as ABM-type communications or connections. Passive component 256 may then route (e.g., via loopback 270) these ABM-type communications back through controller nodes 252, 254 over existing cache coherency connections (e.g., show by “A”, “B”, “C” and “D” in FIG. 2), through controller nodes 202, 204 in enclosure 200, and eventually to ABM 206. ABM 206 may then communicate with controller nodes 252, 254 via a similar reverse path. Loopback 270 may include electronic circuitry and/or may execute instructions to perform the various routing functions of the passive component described herein.

It may be beneficial to describe one specific communication path between a controller node (e.g., 254) of enclosure 250 and ABM 206. Assume that controller node 254 attempts to communicate with what controller node 254 may think is a local ABM. For example, controller node 254 may think that a local ABM is installed where passive component 256 is installed. Thus, node processor 260 in controller node 254 may send an ABM-type communication to passive component 256. Passive component 256 may then route (e.g., via loopback 270) that communication, as shown in FIG. 2, controller node 252. Then, controller node 252 may route (e.g., via connection 269, interface 268 and existing cache coherency connection “A”) that communication to controller node 202 in enclosure 200. For routing this communication over connection “A,” unused or spare pins or wires may be used given that this connection ‘A’ may already exist (e.g., for cache coherency purposes) in various storage cluster configurations. Controller node 202 may then route (e.g., via interface 216 and connection 217) that communication to ABM 206. ABM 206 may then respond to controller node 254 via a similar reverse path. For example, ABM 206 may send a communication to controller node 202. Controller node 202 may then route (e.g., via connection 219, interface 216 and existing cache coherency connection “B”) that communication to controller node 254 in enclosure 250. Controller node 254 may then route (e.g., via interface 276 and connection 277) that communication to passive component 256. Passive component 256 may then route (e.g., via loopback 270) that communication to node processor 260 of controller node 254, as shown in FIG. 2.

It may be seen from the above example, that for controller node 254, communications that are routed to enclosure 200 may leave enclosure 250 via controller node 252 (e.g., via interface 268), and communications that are received from enclosure 200 may enter enclosure 250 via controller node 254 (e.g., via interface 276). In other words, the Ethernet transmit and receive connections used to communicate from enclosure 250 to enclosure 200 may be separated in enclosure 250 and may be rejoined in enclosure 200. This is one example of how the present disclosure wires the controller nodes and enclosures of the storage cluster such that existing best practices for cache coherency wiring (i.e., a standard connectivity scheme) may be maintained while still allowing controller nodes in enclosures without an ABM to communicate with the single active ABM without extra wiring. In other words, four-node cluster wiring schemes used for other mesh topology storage clusters may be used for the solutions of the present disclosure.

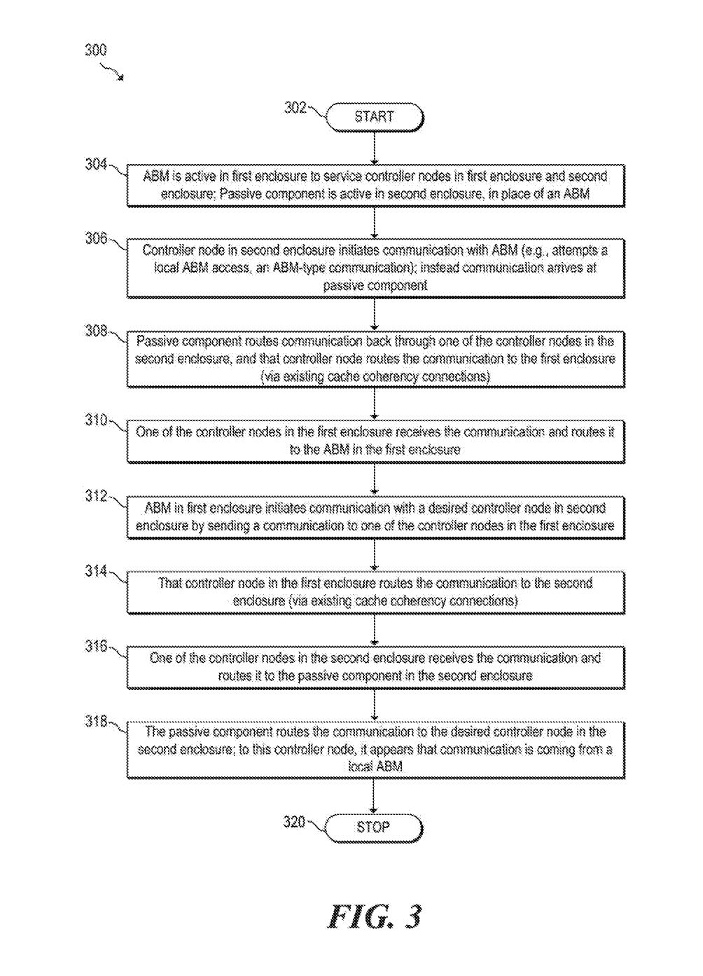

FIG. 3 is a flowchart of an example method 300 for using a single array based manager (ABM) in a mesh topology storage cluster. The execution of method 300 is described below with reference to two enclosures and for controller nodes (two in each enclosure), which may describe a four-node storage cluster similar to that shown in FIG. 2, for example. Method 300 may be executed in a similar manner to that described below for storage cluster configurations that include different numbers of enclosures and/or controller nodes (e.g., an 8-node configuration). Method 300 may be executed by various components of a storage cluster (e.g., the storage cluster depicted in FIG. 2), for example, by at least one of the controller nodes 202, 204, 252, 254, by ABM 206 and/or by passive component 256. Each of these components may include electronic circuitry and/or may execute instructions stored on at least one embedded machine-readable storage medium. In alternate embodiments of the present disclosure, one or more blocks of method 300 may be executed substantially concurrently or in a different order than shown in FIG. 3. In alternate embodiments of the present disclosure, method 300 may include more or less blocks than are shown in FIG. 3. In some embodiments, one or more of the blocks of method 300 may, at certain times, be ongoing and/or may repeat.

Method 300 may start at block 302 and continue to block 304, where an ABM (e.g., 206 of FIG. 2) may be active in a first enclosure (e.g., 200) to service controller nodes in the first enclosure and in a second enclosure (e.g., 253). Also at block 304, a passive component (e.g., 256) may be active in the second enclosure, e.g., in place of an ABM in the second enclosure. At block 306, a controller node (e.g., 254) in the second enclosure may initiate communication with the active ABM (e.g., 206). For example, the controller node (e.g., 254) may attempt a local access to a local ABM (e.g., referred to as an ABM-type communication). Instead of the communication going to a local ABM, it may arrive at the passive component (e.g., 256). At block 308, the passive component may route the communication back through one of the controller nodes (e.g., 252, 254) in the second enclosure, and that controller node may route the communication to the first enclosure (e.g., 200), for example, via existing cache coherency connections, as described in more detail above. At block 310, one of the controller nodes (e.g., 202, 204) in the first enclosure may receive the communication and route it to the active ABM (e.g., 206) in the first enclosure.

At block 312, the ABM (e.g., 206) in the first enclosure (e.g., 200) may initiate communication with a desired controller node (e.g., 254) in the second enclosure (e.g., 250), by sending a communication to one of the controller nodes (e.g., 202, 204) in the first enclosure. At block 314, that controller node in the first enclosure may route the communication to the second enclosure (e.g., 250), for example, via existing cache coherency connections, as described in more detail above. At block 316, one of the controller nodes (e.g., 252, 254) in the second enclosure may receive the communication and route it to the passive component (e.g., 256) in the second enclosure. At block 318, the passive component may route the communication to the desired controller node (e.g., 254) in the second enclosure. For example, to this controller node (e.g., 254) in the second enclosure, it may appear as though the communication is coming from a local ABM. In reality, the communication may be coming from the local passive component (e.g., 256), and may have been initiated by the active ABM (e.g., 206) in the first enclosure. Method 300 may eventually continue to block 320, where method 300 may stop.

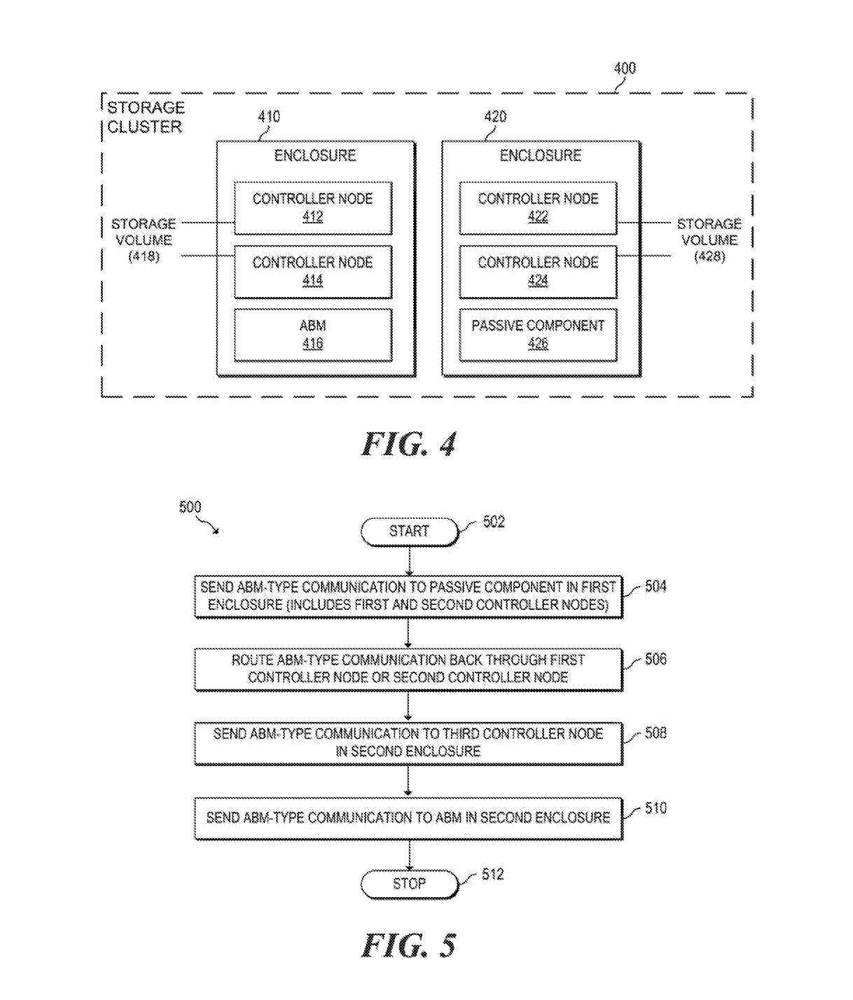

FIG. 4 is a block diagram of an example mesh topology storage cluster 400 with a single array based manager (ABM) 416. In the example of FIG. 4, storage cluster 400 may include two enclosures 410, 420. Each enclosure may be in communication with at least one storage volume (e.g., 418, 428). Each enclosure may include two controller nodes (e.g., 412 and 414 in enclosure 410; 422 and 424 in enclosure 420). Each controller node may be any computing device that is capable of communicating with at least one host (e.g., 102 of FIG. 1) and with at least one storage volume (e.g., 418, 428). Enclosure 410 may include an ABM 416 to monitor paths to the first storage volume via the first pair of controller nodes and to monitor paths to the second storage volume via the second pair of controller nodes. ABM 416 may be a computing device (e.g., a circuit board) and may include electronic circuitry and/or may execute instructions via a processor (e.g., 222 of FIG. 2) to perform the functions of the ABM as described herein. Enclosure 420 may include a passive component 426 to route ABM-type communications of the second pair of controller nodes to the ABM. Passive component 426 may be a computing device (e.g., a circuit board) and may include electronic circuitry and/or may execute instructions via a processor to perform the functions of the passive component as described herein. More details regarding a mesh topology storage cluster may be described above, for example, with respect to FIGS. 1 and 2.

FIG. 5 is a flowchart of an example method 500 for using a single array based manager (e.g., 416) in a mesh topology storage cluster (e.g., 400). Method 500 may be described below as being executed or performed in storage cluster 400; however, method 500 may executed or performed in other suitable storage clusters as well, for example, those shown and described with regard to FIGS. 1 and 2. Method 500 may be executed by various components of storage cluster 400, for example, by at least one of the controller nodes 412, 414, 422, 424, by ABM 416 and/or by passive component 426. Each of these components may include electronic circuitry and/or may execute instructions stored on at least one embedded machine-readable storage medium. In alternate embodiments of the present disclosure, one or more blocks of method 500 may be executed substantially concurrently or in a different order than shown in FIG. 5. In alternate embodiments of the present disclosure, method 500 may include more or less blocks than are shown in FIG. 5. In some embodiments, one or more of the blocks of method 500 may, at certain times, be ongoing and/or may repeat.

Method 500 may start at block 502 and continue to block 504, where a first controller node (e.g., 422) in a first enclosure (e.g., 420) may said an ABM-type communication to a passive component (e.g., 428) of the first enclosure. At block 506, the passive component may route the ABM-type communication back through the first controller node (e.g., 422) or a second controller node (e.g., 424) of the first enclosure. At block 508, the first controller node (e.g., 422) or the second controller node (e.g., 424) may send the ABM-type communication to a third controller node (e.g., 412) of a second enclosure (e.g., 410), via a cache coherency connection. At block 510, the third controller node may send the ABM-type communication to an ABM (e.g., 416) in the second enclosure. Method 500 may eventually continue to block 512, where method 500 may stop.

In alternate embodiments of the present disclosure, and referring to FIG. 2 for reference, instead of the controller nodes (e.g., 252, 254) in the non-ABM enclosure (e.g., 250) sending ABM-type communications to a passive component and then, in turn, to enclosure 200 via cache coherency connections, the controller nodes 252, 254 in enclosure 250 may send ABM-type communications to ABM 206 via additional external connections (i.e., connections that are physically separate from the cache coherency connections). For example, intercontroller component 258 may include wiring paths that route ABM-type signals from the node processors in controller nodes 252, 254 out of enclosure 250 and to ABM 206, via the external connections. Then, in enclosure 200, the external connections may route directly into ABM 206 (in which case ABM 206 may include an appropriate interface) or may route into intercontroller 208, which may then route the connections to ABM 206 (e.g., into switch 220). Such a solution may require additional bulkhead space on the ABM or on the intercontroller component to permit direct connections from the controller nodes in enclosure 250. In some situations, such additional bulkhead space may be unavailable or inconvenient.

In alternate embodiments of the present disclosure, and referring to FIG. 2 for reference, instead of the controller nodes (e.g., 252, 254) in the non-ABM enclosure (e.g., 250) sending ABM-type communications to a passive component and then, in turn, to enclosure 200 via cache coherency connections, the controller nodes 252, 254 in enclosure 250 may send ABM-type communications to ABM 206 via additional external connections (i.e., connections that are physically separate from the cache coherency connections) and an external switch (e.g., Ethernet switch). For example, node processors (e.g., 260) in controller nodes 252, 254 may each include an Ethernet port for communicating ABM-type communications over external Ethernet cables to an external switch. The switch may, in turn, send such ABM-type communications to ABM 206. Such a solution may be asymmetrical, meaning that two nodes (e.g., in enclosure 200) would send ABM-type communications internally (e.g., via intercontroller component 208) and two nodes (e.g., in enclosure 250) would send ABM-type communications externally via Ethernet ports. Additionally, the required external wiring and the external switch may be cumbersome and difficult to deploy.

1. A mesh topology storage cluster, comprising:
a first pair of controller nodes to access a first storage volume;
a second pair of controller nodes to access a second storage volume;
an array based manager (ABM) associated with the first pair of controller nodes to monitor paths to the first storage volume via the first pair of controller nodes and to monitor paths to the second storage volume via the second pair of controller nodes; and
a passive component associated with the second pair of controller nodes to route ABM-type communications of the second pair of controller nodes to the ABM.

2. The mesh topology storage cluster of claim 1, wherein the ABM to directly connect to the first pair of controller nodes and to indirectly connect to the second pair of controller nodes via the first pair of controller nodes.

3. The mesh topology storage cluster of claim 2, wherein the ABM to directly connect to the first pair of controller nodes via an intercontroller component associated with the first pair of controller nodes.

4. The mesh topology storage cluster of claim 2, wherein the first pair of controller nodes to connect to the second pair of controller nodes via at least one cache coherency connection, and wherein the ABM to indirectly connect to the second pair of controller nodes via the at least one cache coherency connection.

5. The mesh topology storage cluster of claim 4, wherein the ABM to indirectly connect to the second pair of controller nodes via spare pins or wires in the at least one cache coherency connection.

6. The mesh topology storage cluster of claim 1, wherein the passive component to route the ABM-type communications back through at least one controller node in the second pair of controller nodes, to cause the ABM-type communications to route to at least one controller node in the first pair of controller nodes, and then to the ABM.

7. The mesh topology storage cluster of claim 1, wherein the first pair of controller nodes is included within a first physical enclosure and the second pair of controller nodes is included within a second physical enclosure.

8. An enclosure for a mesh topology storage cluster, comprising:
a first pair of controller nodes to access a first storage volume; and
a passive component to route ABM-type communications of the first pair of controller nodes to an array based manager (ABM) included in a second enclosure of the mesh topology storage cluster, wherein the ABM to monitor paths to the first storage volume via the first pair of controller nodes, wherein the ABM-type communications to be routed through the first pair of controller nodes and to a second pair of controller nodes in the second enclosure.

9. The enclosure of claim 8, wherein the first pair of controller nodes to connect to the second pair of controller nodes via at least one cache coherency connection, and wherein the ABM-type communications to route through the at least one cache coherency connection.

10. The enclosure of claim 9, wherein the ABM-type communications to route via spare pins or wires in the at least one cache coherency connection.

11. The enclosure of claim 8, wherein the a passive component is further to receive communications from the ABM via the first pair of controller nodes, and wherein the passive component to route such communications back to the appropriate controller node of the first pair of controller nodes.

12. The enclosure of claim 8, wherein the passive component to directly connect to the first pair of controller nodes via an intercontroller component associated with the first pair of controller nodes.

13. A method for using an array based manager (ABM) in a mesh topology storage cluster, the method comprising:
sending, by a first controller node in a first enclosure, an ABM-type communication to a passive component of the first enclosure;
routing, by the passive component, the ABM-type communication back through the first controller node or a second controller node of the first enclosure;
sending the ABM-type communication to a third controller node of a second enclosure via a cache coherency connection; and
sending, by the third controller node, the ABM-type communication to an ABM in the second enclosure.

14. The method of claim 13, wherein the ABM-type communication is sent to the third controller node via spare pins or wires in the cache coherency connection.

15. The method of claim 13, further comprising:
sending, via the ABM, a second communication to the third controller node or a fourth controller node of the second enclosure, wherein the second communication is intended for the first controller node;
sending the second communication to the first controller node or the second controller node via a cache coherency connection;
sending, by the first controller node or the second controller node, the second communication to the passive component, and
routing, by the passive component, the second communication to the first controller node.
